(19) United States
(12) Patent Application Publication
(10) Pub. No.: US 2022/0185095 A1
(43) Pub. Date: Jun. 16, 2022

(54) Transmission Assembly for a Motor Vehicle Powertrain, Powertrain, and Method for Controlling Same

(71) Applicant: ZF Friedrichshafen AG, Friedrichshafen (DE)

(72) Inventors: Stefan Beck, Eriskirch (DE); Johannes Kaltenbach, Friedrichshafen (DE); Matthias Horn, Tettnang (DE); Michael Wechs, Weißensberg (DE); Thomas Martin, Weissensberg (DE); Max Bachmann, Friedrichshafen (DE); Martin Brehmer, Tettnang (DE); Peter Ziemer, Tettnang (DE); Oliver Bayer, Hörbranz (AT); Thomas Kroh, Lindau (DE); Fabian Kutter, Kressbronn (DE)

(21) Appl. No.: 17/435,904

(22) PCT Filed: Oct. 15, 2019
(86) PCT No.: PCT/EP2019/077949

§ 371 Date: Sep. 2, 2021

(30) Foreign Application Priority Data
Mar. 5, 2019 (DE) 10 2019 202 962.0

(51) Int. Cl. B60K 6/547; F16D 21/06; B60K 6/40; B60K 6/387; F16H 3/091; F16H 3/093

(52) U.S. Cl. CPC B60K 6/547; F16D 21/06; B60K 6/40; F16D 13/385; F16H 3/091; F16H 3/093; B60K 6/387

(57) ABSTRACT

A transmission arrangement for a motor vehicle drive train (10) includes a first input shaft (12), a second input shaft (24), a countershaft (40), a first sub-transmission (26), which includes a first plurality of engageable gear sets (30, 32) for establishing a number of gear steps, a second sub-transmission (28), which includes a second plurality of engageable gear sets (34, 36) for establishing a number of gear steps, and a bridge clutch (S3), which is configured for coupling the first sub-transmission (26) and the second sub-transmission (28) in order to establish at least one winding-path gear step (V1, V6).

### CROSS-REFERENCE TO RELATED APPLICATIONS

The present application is related and has right of priority to German Patent Application No. 102019202962.0 filed in the German Patent Office on Mar. 5, 2019 and is a nationalization of PCT/EP2019/077949 filed in the European Patent Office on Oct. 15, 2019, both of which are incorporated by reference in their entirety for all purposes.

### FIELD OF THE INVENTION

The present invention relates generally to a transmission arrangement for a motor vehicle drive train, with a first input shaft and a second input shaft, with a countershaft, with a first sub-transmission, which includes a first plurality of engageable gear sets for establishing a number of gear steps, and with a second sub-transmission, which includes a second plurality of engageable gear sets for establishing a number of gear steps.

The present invention further relates generally to a drive train for a motor vehicle, with an internal combustion engine, with a dual-clutch assembly, which includes an input element connected to the internal combustion engine and two output elements, and with a transmission arrangement of the above-described type, wherein the first input shaft and the second input shaft are each connected to one of the output elements.

The present invention further relates generally to a hybrid drive train and to a method for operating a hybrid drive train.

### BACKGROUND

A transmission arrangement of the above-described type is known from document DE 10 2016 210 713 A1. The transmission disclosed therein includes a transmission shaft, a first shaft, a first idler gear associated with the first shaft, a first other idler gear associated with the first shaft, a second shaft, a second idler gear associated with the second shaft, and a second other idler gear associated with the second shaft. The transmission shaft is operatively connectable to the first shaft and/or to the second shaft. The transmission includes a transmission output shaft, which is operatively connected to the first shaft and to the second shaft. The first idler gear is rotationally fixable to the first other idler gear by a first shift element. In an engaged condition of the first shift element, either a first forward gear for a forward operation or a sixth forward gear for a forward operation is implementable. Moreover, the transmission is integratable into a hybrid drive train.

The above-described transmission is generally to be associated with dual-clutch transmissions. Dual-clutch transmissions have represented an alternative to torque converter automatic transmissions for several years. Dual-clutch transmissions have a dual-clutch assembly, which is connectable on the input side to a prime mover such as an internal combustion engine. An output element of a first clutch of the clutch assembly is connected to a first input shaft of a first sub-transmission, which is typically associated with the even forward gear steps or with the odd forward gear steps. An output element of a second friction clutch of the dual-clutch assembly is connected to a second input shaft of a second sub-transmission, which is typically associated with the other forward gear steps.

The gear steps associated with the sub-transmissions can generally be engaged and disengaged in an automated manner. During normal operation, one of the friction clutches of the dual-clutch assembly is engaged. In the other, inactive, sub-transmission, a connecting gear step can then be engaged in advance. A gear change can then be carried out essentially without interruption of tractive force by an overlapping actuation of the two friction clutches.

Certain motor vehicle transmissions are generally designed for the front transverse installation in a motor vehicle, wherein attention is paid, in particular, to a short axial installation length. Alternatively, transmissions are designed for a longitudinal installation in a motor vehicle, wherein attention is paid, in particular, to a radially compact design.

In the front-mounted transverse transmissions, two countershafts arranged axially parallel are frequently associated with an input shaft arrangement, and so the power flow from the input shaft arrangement can take place either via the one countershaft or via the other countershaft. The countershafts are also designed as output shafts and, in general, are both in engagement with a differential for distributing input power to driven wheels. This type of transmission has become known, for example, from the aforementioned document DE 10 2016 210 713 A1.

A further trend in the field of motor vehicle drive trains is hybridization. In general, this means a prime mover in the form of an internal combustion engine has associated therewith an electric machine, as a further prime mover. Here, a distinction is made between a plurality of different concepts, which each provide a different connection of the electric machine to the transmission. In a typical variant of dual-clutch transmissions (see also the aforementioned document DE 10 2016 210 713 A1), an electric machine is to be arranged concentrically to an input element of the dual-clutch assembly. In order to be able to utilize the electric machine, in this case, not only for assisting the internal combustion engine, but rather also to be able to set up a purely electric motor-driven operation, the input element of the dual-clutch assembly is generally connected to the internal combustion engine by a separating clutch or an internal combustion engine-decoupling device.

The hybridization of transmissions, with respect to the requirements mentioned at the outset, places high requirements on radial and/or axial installation space.

### SUMMARY OF THE INVENTION

Example aspects of the invention provide an improved transmission arrangement, an improved drive train for a motor vehicle, an improved hybrid drive train, and an improved method for operating a hybrid drive train.

Example aspects of the present invention provide, on the one hand, a transmission arrangement for a motor vehicle drive train, with a first input shaft and a second input shaft, with a countershaft, with a first sub-transmission, which includes a first plurality of engageable gear sets for establishing a number of gear steps, with a second sub-transmission, which includes a second plurality of engageable gear sets for establishing a number of gear steps, and with a bridge clutch, which is designed for coupling the first sub-transmission and the second sub-transmission in order to establish at least one winding-path gear step.

Example aspects of the present invention also provide a drive train for a motor vehicle, with an internal combustion engine, with a dual-clutch assembly, which includes an input element connected to the internal combustion engine and two output elements, and with a transmission arrangement of the above-described type, wherein the first input shaft and the second input shaft are each connected to one of the output elements.

Moreover, example aspects of the present invention provide a hybrid drive train with a transmission arrangement of the above-described type and with a first electric machine, which is connected to an input element of a dual-clutch assembly, the output elements of which are connected to the first input shaft and to the second input shaft, respectively, and/or with a second electric machine, which is connected to the first input shaft or to the second input shaft.

Finally, example aspects of the present invention provide a method for operating a hybrid drive train of the type according to example aspects of the invention, including synchronizing gear changes of the unsynchronized gearshift clutches by the first electric machine and/or by the second electric machine.

In the transmission arrangement according to example aspects of the invention, the first input shaft and the second input shaft are preferably arranged concentrically to each other, wherein the first input shaft is preferably designed as a hollow shaft and wherein the second input shaft is preferably designed as an inner shaft. The transmission arrangement preferably includes precisely one countershaft. Preferably, the one countershaft is simultaneously an output shaft of the transmission arrangement. For this purpose, the countershaft is preferably connected to an output gear, which is designed for driving a power distribution arrangement, such as a differential.

Engageable gear sets are understood to be, in the present case, gear sets that include an idler gear and a fixed gear, which are in engagement with each other in an intermeshed manner, and which are engageable by an associated gearshift clutch. In an engaged gear set, the idler gear of this gear set is rotationally fixed to the associated shaft. The gear sets are preferably spur gear trains, which preferably connect one of the two input shafts and the countershaft to each other, in each case.

A regular forward gear step, i.e., a fixed ratio, is preferably associated with each gear set. A regular forward gear step is understood to be a forward gear step that is engageable into the power flow by engaging a single gearshift clutch or a single shift element.

At least one winding-path gear step can be established, however, by the bridge clutch. The at least one winding-path gear step is preferably a forward winding-path gear step. Upon establishment of a winding-path gear step, power flows from the first sub-transmission to the second sub-transmission, or vice versa. In order to establish a winding-path gear step, generally, the bridge clutch is to be engaged, as well as one further gearshift clutch and/or one further shift element. In other words, in order to establish a winding-path gear step, generally, at least two shift elements are to be engaged, in contrast to a regular forward gear step, in which only one shift element is to be engaged.

The first sub-transmission is associated with the even forward gear steps in one preferred example embodiment and with the odd gear steps in an alternative example embodiment. In a corresponding way, the second sub-transmission is associated with the odd forward gear steps in one preferred example variant and with the even gear steps in an alternative example embodiment.

The transmission arrangement is preferably connected to a dual-clutch assembly, wherein the first input shaft is preferably connected to one clutch of the dual-clutch assembly, and wherein the other input shaft is preferably connected to the other clutch of the dual-clutch assembly.

A connection is understood to mean, in the present case, that a rotationally fixed coupling is established, i.e., an operative connection, in which the elements connected to each other rotate at a proportional rotational speed.

In the hybrid drive train, the electric machine generally includes a rotor and a stator. The stator is generally fixed to the housing. The rotor, in one example embodiment, is rotationally fixed to a shaft of the transmission arrangement, for example, to a shaft section of an input element of the dual-clutch assembly. Alternatively, the rotor can be connected to an engine/motor pinion, which is part of a machine-coupling gear set, in order to transmit power to a shaft and, in fact, by a spur gear train.

In the method according to example aspects of the invention, the transmission arrangement can include synchromesh shift elements and/or gearshift clutches, which are designed as friction clutches. These types of shift elements are typically implemented as lock-synchronizer mechanisms. In the hybrid drive train, however, a few shift elements can also be implemented as non-synchronized shift elements and/or dog clutches, which are generally engaged only if a synchronization of the elements to be connected to each other has taken place, wherein the synchronization takes place, in particular, by the first electric machine and/or the second electric machine.

With the transmission arrangement according to example aspects of the invention, it is possible to implement functionalities such as those known from document DE 10 2016 210 713 A1 by only one single connection to a power distribution unit (for example, a differential). In this way, installation space can be created and, in fact, in particular for integrating at least one electric machine for establishing a hybrid drive train, in particular for connecting an electric machine in an axially parallel way, in such a way that the electric machine is connected to the transmission arrangement via a machine-coupling gear set in the form of a spur gear train.

In one preferred example variant, the order of the elements starting from the input of the transmission arrangement is as follows: gear set for a second forward gear step 2, gearshift clutch assembly for the second and fourth forward gear steps 2 and 4, gear set for the fourth forward gear step 4, gear set for the third forward gear step 3, gearshift clutch assembly for the third and fifth forward gear steps 3 and 5, and gear step for the fifth forward gear step 5.

In an alternative example embodiment, the axial order of the elements in the transmission arrangement is as follows: gear set for the fifth forward gear step 5, gearshift clutch assembly for the forward gear fifth and third steps 5 and 3, gear set for the third forward gear step 3, gear set for the fourth forward gear step 4, gearshift clutch assembly for the fourth and second forward gear steps 4 and 2, and gear step for the second forward gear step 2.

In one preferred example embodiment, all gearshift clutches are arranged at the countershaft, although the gearshift clutches can also be at least partially arranged at one of the input shafts.

Preferably, the bridge clutch is also arranged at the countershaft. In one alternative example embodiment, the bridge clutch is arranged at a further countershaft, which is connected to the first sub-transmission and to the second sub-transmission via coupling gear sets.

In the hybrid drive train, an electric machine can be connected to the drive train upstream from the dual-clutch assembly. In this case, the electric machine can be configured for the boost mode, for starting the internal combustion engine, and for a number of other purposes. When an internal combustion engine-decoupling device is provided, an electric motor-driven operation can also take place in all gear steps.

Alternatively or additionally, an electric machine is connected at an input of one of the sub-transmissions. In this case, an electric operation can take place via that sub-transmission. The electric machine can also be utilized for boosting, however, and in an operation as a generator for charging a battery, and for starting the internal combustion engine, etc.

According to one preferred example embodiment, the bridge clutch is arranged at the countershaft.

In this example embodiment, a radially compact design can be implemented.

Here, it is preferred when the bridge clutch is arranged axially between the first sub-transmission and the second sub-transmission.

As a result, the coupling of the sub-transmissions can be implemented in a structurally simple manner.

According to a further example embodiment, the bridge clutch is arranged at a further countershaft, which is coupled to the first sub-transmission via a first coupling gear set and to the second sub-transmission via a second coupling gear set.

The coupling gear sets preferably include a constant gear set, which is not engageable, and an engageable gear set, which is engageable by the bridge clutch.

Due to the arrangement of the bridge clutch at a further countershaft, an axially compact design can be implemented.

It is particularly preferred here when the bridge clutch is arranged axially outside an axial gap between the first coupling gear set and the second coupling gear set. At least one of the coupling gear sets includes a fixed gear of a gear set for establishing a regular forward gear step.

It is further preferred, overall, when the first sub-transmission and/or the second sub-transmission include(s) precisely two gear sets, which are associated with regular forward gear steps.

It is particularly preferred when the first sub-transmission includes gear sets for the second and fourth forward gear steps 2 and 4 or when the first sub-transmission includes gear sets for the third and fifth forward gear steps 3 and 5. Moreover, it is preferred when the second sub-transmission in the first example variant, above, includes two gear sets for the third and fifth forward gear steps 3 and 5, and, in the second example variant, gear sets for the second and fourth forward gear steps 2 and 4.

According to one further example embodiment preferred overall, the ratios of the gear sets of the first sub-transmission and/or of the second sub-transmission are matched to each other in such a way that a first forward winding-path gear step has a shorter ratio than all gear sets of the first sub-transmission and of the second sub-transmission that are associated with regular forward gear steps, and/or in such a way that a second forward winding-path gear step has a longer ratio than all gear sets of the first sub-transmission and of the second sub-transmission that are associated with regular forward gear steps.

In this example embodiment, use is made of the fact that generally at least two gear sets are involved when a winding-path gear step is established, and so either a very long ratio or a very short ratio is establishable. Preferably, the first forward winding-path gear step is the starting gear step of the transmission arrangement. The second forward winding-path gear step is preferably the forward gear step having the longest or highest ratio, i.e., for example, in the above-described case having four gear sets, a ratio corresponding to the sixth forward gear step 6.

With respect to the hybrid drive train according to example aspects of the invention, it is preferred when the input element of the dual-clutch assembly is connected to an internal combustion engine-decoupling device, via which an internal combustion engine is connectable to the input element.

As a result, for the case in which an electric machine is connected to the input element of the dual-clutch assembly, an electric operation can be established, without the need to entrain the internal combustion engine.

Moreover, it is advantageous when the first electric machine is connected to the input element via a first machine-coupling gear set and/or when the second electric machine is connected to the first input shaft or to the second input shaft via a second machine-coupling gear set.

In this way, the electric machine(s) can be integrated in an axially parallel manner, in order to be able to implement, in this way, a compact design, in particular in the axial direction.

According to one further example embodiment preferred overall, the first electric machine is connected to the input element of the dual-clutch assembly, wherein the second electric machine is connected to the first input shaft or to the second input shaft, wherein the gear sets of the sub-transmission that is associated with the second electric machine are engageable by unsynchronized gearshift clutches and/or dog clutches.

According to one further preferred example embodiment, the first electric machine is connected to the input element of the dual-clutch assembly, wherein the second electric machine is connected to the first input shaft or to the second input shaft, and wherein the dual-clutch assembly includes a first and/or a second unsynchronized gearshift clutch and/or dog clutch.

According to one further example embodiment preferred overall, the internal combustion engine-decoupling device includes an unsynchronized gearshift clutch or dog clutch.

It is understood that the features, which are mentioned above and which will be described in greater detail in the following, are usable not only in the particular combination indicated, but also in other combinations or alone, without departing from the scope of the present invention.

### BRIEF DESCRIPTION OF THE DRAWINGS

Exemplary embodiments of the invention are represented in the drawings and are explained in greater detail in the following description, wherein:

FIG. 1 shows a schematic of an example embodiment of a drive train according to the invention;

FIG. 2 shows a drive train with a modified example transmission arrangement;

FIG. 3 shows a gearshift table of the drive trains from FIGS. 1 and 2;

FIG. 4 shows an example modification of the drive train shown in FIG. 1;

FIG. 5 shows an example modification of the drive train shown in FIG. 2;

FIG. 6 shows an example modification of the drive train from FIG. 1, wherein a first electric machine is coaxially integrated into the drive train;

FIG. 7 shows an example modification of the drive train shown in FIG. 1, wherein a first electric machine is connected to an input element of a dual-clutch assembly via a machine-coupling gear set;

FIG. 8 shows an example modification of the drive train from FIG. 1, wherein a second electric machine is connected to the second input shaft via a machine-coupling gear set;

FIG. 9 shows an example modification of the drive train from FIG. 1, wherein a second electric machine is connected to the first input shaft;

FIG. 10 shows an example modification of the drive train from FIG. 1, wherein a first electric machine is connected to an input element of a dual-clutch assembly, and wherein a second electric machine is connected to the second input shaft; and

FIG. 11 shows an example modification of the drive train from FIG. 2, wherein a first electric machine is connected to an input element of a dual-clutch assembly, and wherein a second electric machine is connected to the first input shaft.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

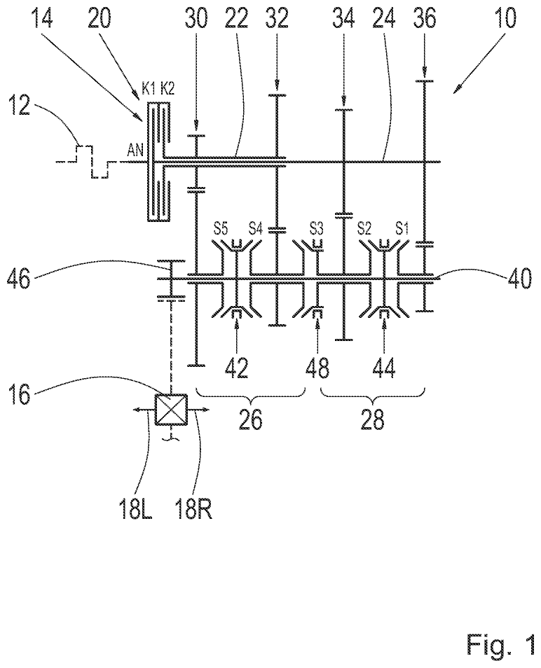

In FIG. 1, an example embodiment of a drive train for a motor vehicle, in particular for a passenger car, according to example aspects of the invention is represented and is labeled in general with 10. The drive train 10 includes an internal combustion engine 12, which is connected to a dual-clutch assembly 14, which is connected on the output side to a differential 16, by which input power is distributable onto driven wheels 18L, 18R.

The dual-clutch transmission 14 includes a dual-clutch assembly 20, which includes two clutches K1, K2. The clutches K1, K2 are preferably designed as friction clutches, unless otherwise stated, for example, as wet-running multi-disk clutches.

The dual-clutch transmission 14 includes a first input shaft 22 and a second input shaft 24. The first input shaft 22 is designed as a hollow shaft and is connected to an output element of the clutch K2. The second input shaft 24 is arranged concentrically to the first input shaft 22 and is designed as an inner shaft. The second input shaft 24 is connected to an output element of the clutch K1.

The first input shaft 22 is associated with a first sub-transmission 26, which includes regular forward gear steps, in the present case the regular even forward gear steps 2 and 4. The second input shaft 24 is associated with a second sub-transmission 28, which is associated with regular odd forward gear steps, in the present case the regular odd forward gear steps 3 and 5.

The two sub-transmissions 26, 28 are arranged axially offset with respect to each other.

The first sub-transmission 26 includes a gear set 30 for the regular second forward gear step 2, and a gear set 32 for the regular fourth forward gear step 4. The second sub-transmission 28 includes a gear set 34 for the regular third forward gear step 3 and a gear set 36 for the regular fifth forward gear step 5.

The gear sets 30, 32, 34, 36 each include a fixed gear and an idler gear and, in each case, connect one of the input shafts 22, 24 to a countershaft 40.

The first sub-transmission 26 includes a first gearshift clutch assembly 42 with shift elements S5, S4 for engaging the second and fourth regular forward gear steps 2 and 4. The second sub-transmission 28 includes a second gearshift clutch assembly 44 with shift elements S2 and S1 for engaging the third and fifth regular forward gear steps 3 and 5.

The gearshift clutch assemblies 42, 44 are preferably arranged at the countershaft 40. In a corresponding way, the fixed gears of the gear sets 30, 32, 34, 36 are preferably connected to the associated input shafts 22 and 24, and idler gears of the gear sets 30, 32, 34, 36 are rotatably mounted at the countershaft 40 and are connectable to the countershaft 40 by the particular shift elements.

The countershaft 40 is connected to an output gearwheel 46, by which the differential 16 is driven.

By engaging one of the shift elements S1, S2, S4, S5, a regular forward gear step can be engaged in each case.

A bridge clutch arrangement 48 is arranged axially between the two sub-transmissions 26, 28 and includes a shift element S3, which is designed for connecting the first sub-transmission 26 and the second sub-transmission 28 to each other. Upon establishment of regular forward gear steps, the shift element S3 of the bridge clutch arrangement 48 is generally disengaged.

When the shift element S3 of the bridge clutch arrangement 48 is engaged, and when, simultaneously, one of the shift elements S1, S2, S4, S5 is engaged, a winding-path gear step can be established, in which power is transmitted from one of the clutches K1, K2 via the associated sub-transmission, then via the bridge clutch arrangement 48 to the other sub-transmission and, from there, to the countershaft 40. These types of gear steps, in which the shift element S3 of the bridge clutch arrangement 48 is engaged and one of the further shift elements S1, S2, S4, S5 is also engaged, are also referred to as winding-path gear steps in the present case.

The ratios of the gear sets 30, 32 of the first sub-transmission 26 and the ratios of the gear sets 34, 36 of the second sub-transmission 28 are matched to each other in such a way that a first forward winding-path gear step has a shorter ratio than all gear sets of the first sub-transmission 26 and of the second sub-transmission 28 that are associated with regular forward gear steps. Moreover, a second forward winding-path gear step has a longer ratio than all gear sets of the first sub-transmission and of the second sub-transmission that are associated with regular forward gear steps.

The transmission arrangement, which is formed, in the present case, by the two sub-transmissions 26, 28 and the output pinion 46, preferably does not include a reverse gear step. The transmission arrangement made up of the sub-transmissions 26, 28 is therefore preferably provided for a hybridization, in which a reverse gear step is established by an electric machine, the direction of rotation of which is easily reversible (in contrast to an internal combustion engine).

In general, it is also conceivable to integrate a gear set for a reverse gear step into the first or into the second sub-transmission 28, for which a further shift element is then generally necessary, however. In the present case, it is advantageous that the shift elements S1 through S5 are actuatable by only three actuators.

The transmission arrangement has a simple configuration and a compact design. Due to the clever arrangement of the gear sets, low component loads result. In particular, the gear set with the shortest ratio (the gear set for the second forward gear step 2) is arranged adjacent to one axial end of the transmission arrangement, i.e., at the point where a mounting of the shafts 22, 24, 40 takes place.

Due to the fact that only the lowest and the highest forward gear steps are implemented as a winding-path gear step, low transmission losses also result. A good gearing efficiency results. In addition, the transmission ratio range can be implemented in a very good way.

Further example embodiments of drive trains, which generally correspond to the drive train 10 from FIG. 1 with regard to configuration and mode of operation, are described below. Identical elements are therefore labeled with identical reference characters. In the following, essentially, the differences are explained.

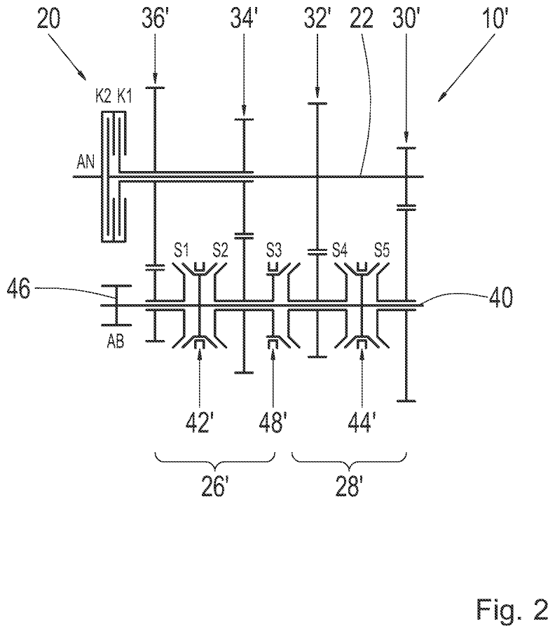

FIG. 2 shows a modified drive train 10′, in which the first sub-transmission 26′ includes gear sets 34′, 36′ for the third and fifth forward gear steps 3 and 5, and the gearshift clutch assembly 44′. In a corresponding way, the second sub-transmission 28′ includes gear sets 30′, 32′ for the second and fourth regular forward gear steps 2 and 4, and a gearshift clutch assembly 48′. The bridge clutch arrangement 48′ is implemented in the form of a comparable arrangement, in which the friction bodies of the shift element S3 are arranged on the side of a synchronizer sleeve facing the second sub-transmission 28′.

In the drive trains 10, 10′, the shift elements are designed as synchronized shift elements, in particular in the form of lock-synchronizer mechanisms.

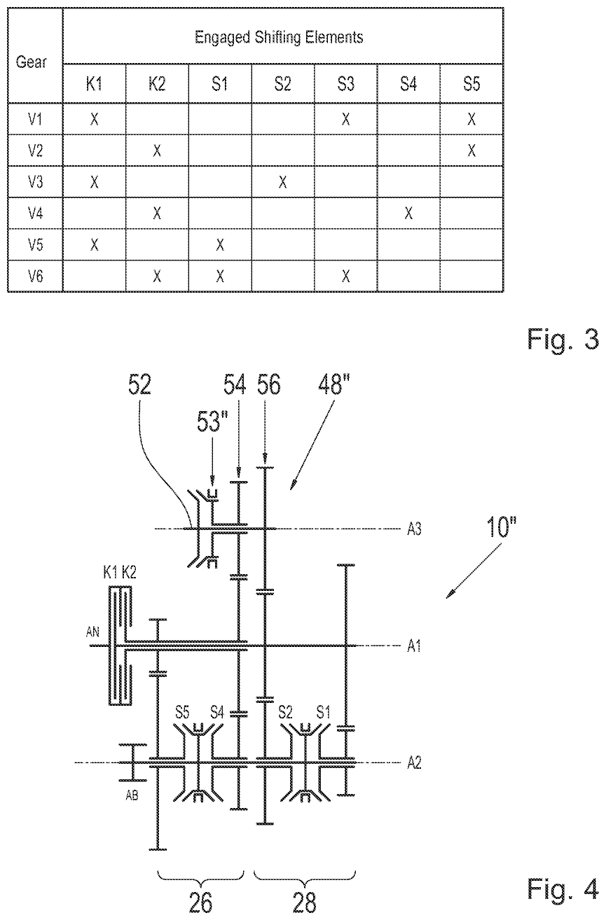

FIG. 3 shows a gearshift table for the forward gear steps V1 through V6.

For example, the forward gear step V1 is established, in that the clutch K1 of the dual-clutch assembly 20 is engaged, as well as the shift element S3 of the bridge clutch arrangement 48 and the shift element S5 of the gear set 30 for the regular forward gear step 2.

In order to engage the forward gear step V2, the shift element S5 remains engaged. The shift element S3 and the clutch K1 are disengaged and the clutch K2 is engaged.

Correspondingly, in the forward gear step V3, the clutch K1 and the shift element S2 are engaged. For the forward gear step V4, the clutch K2 and the shift element S4 are engaged. For the forward gear step V5, the clutch K1 and the shift element S1 are engaged.

For the forward gear step V6, the clutch K2, the shift element S1, and the shift element S3 of the bridge clutch arrangement 48 are engaged.

The gearshift table from FIG. 3 applies for the two drive trains 10, 10′ from FIGS. 1 and 2, respectively.

In the following, further example embodiments of drive trains are explained, which correspond to the above-described drive trains with regard to configuration and mode of operation and are based on the same gearshift table as shown in FIG. 3. In the following, essentially, the differences are explained.

FIG. 4 shows a drive train 10″, in which the bridge clutch arrangement 48″ is arranged at a further countershaft 52. The further countershaft 52 is arranged in parallel to the input shafts and to the countershaft and is connected to the first sub-transmission 26 via a first coupling gear set 54. The first coupling gear set 54 includes an idler gear, which is rotatably mounted at the further countershaft 52 and is in engagement with or meshes with the fixed gear of the gear set for the fourth forward gear step 4. Moreover, the further countershaft 52 is connected to the second sub-transmission 28 via a second coupling gear set 56. More precisely, the second coupling gear set 56 includes a fixed gear, which is rotationally fixed to the further countershaft 52 and is in engagement with the fixed gear of the gear set for the regular third forward gear step 3.

The shift element S3″ of the bridge clutch arrangement 48″ is arranged, viewed axially, outside an axial gap between the first coupling gear set 54 and the second coupling gear set 56. As a result, an axially compact design can be implemented.

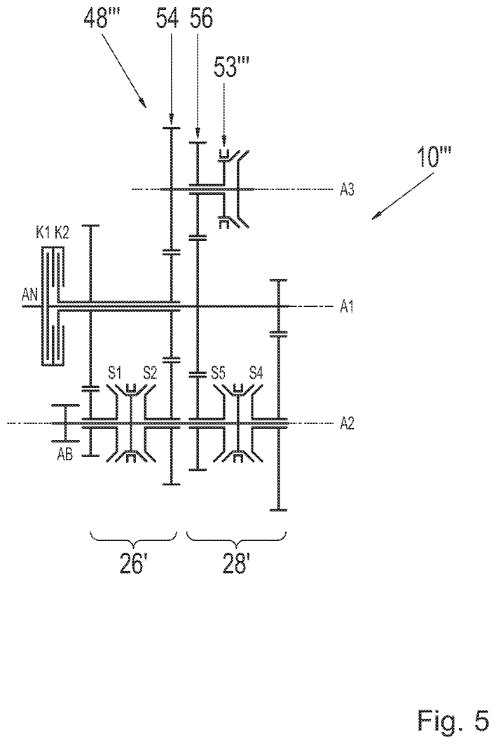

In FIG. 5, a further alternative example embodiment of a hybrid drive train 10′″ is shown, which generally corresponds to the drive train 10″ from FIG. 4 with respect to configuration and mode of operation. While, in the drive train 10″ from FIG. 4, the shift element S3″ is provided in axial overlap with the first sub-transmission 26, the shift element S3′″ of the bridge clutch arrangement 48′″ is arranged on the axially opposite side of the coupling gear sets 54, 56, i.e., in axial overlap with the second sub-transmission 28′. Moreover, in the drive train 10′″, the coupling gear set 54 is designed as a constant gear set and the coupling gear set 56 is designed as an engageable gear set and, in fact, by the shift element S3′″.

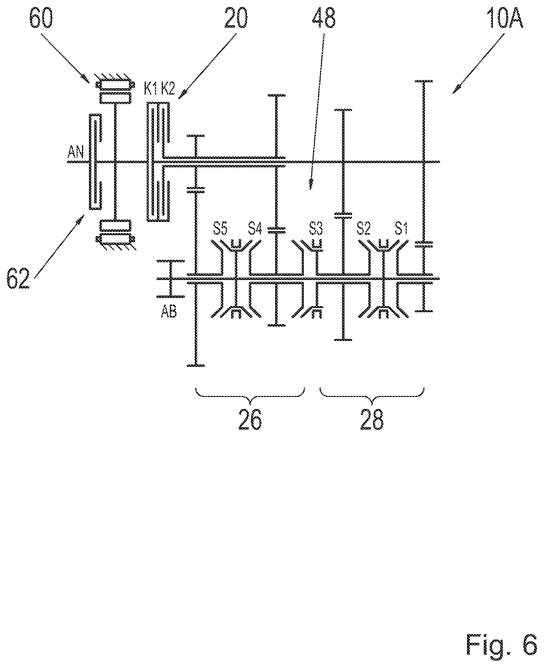

FIG. 6 shows a further example embodiment of a drive train 10A, which generally corresponds to the drive train 10 from FIG. 1 with respect to configuration and mode of operation. The drive train 10A is designed as a hybrid drive train and includes a first electric machine 60, which is arranged coaxially to the input shaft arrangement. A rotor of the electric machine 60 is connected to an input element of the dual-clutch assembly 20. Moreover, the input element of the dual-clutch assembly 20 is connectable to an internal combustion engine 12 via an internal combustion engine-decoupling device 62 (designed as a separating clutch K0.

Due to the internal combustion engine-decoupling device 62, a purely electric operation can be established, without the need to entrain the internal combustion engine. In a purely electric operation, the internal combustion engine-decoupling device 62 is disengaged. In other operating conditions, for example, in a boost mode or for starting the internal combustion engine, the internal combustion engine-decoupling device 62 is engaged.

In a purely internal combustion engine-driven mode as well, the decoupling device 62 is engaged, of course, in order to be able to transmit power from the internal combustion engine 12 to the dual-clutch assembly 20.

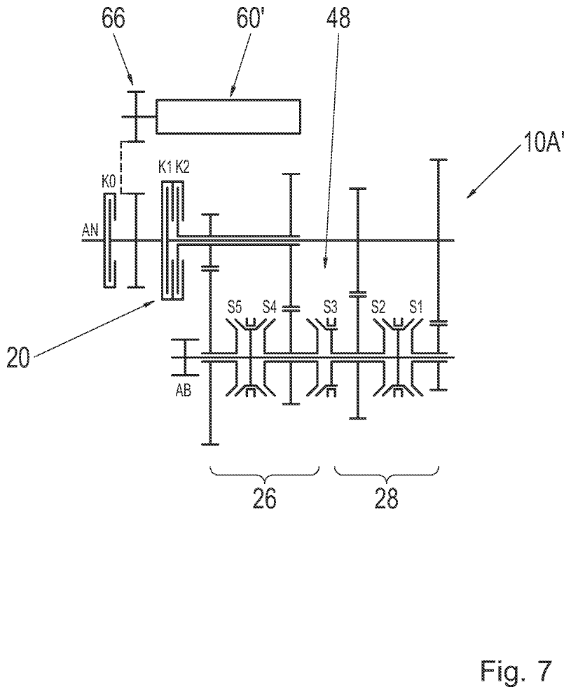

FIG. 7 shows a further example embodiment of a drive train 10A′, which includes a first electric machine 60′, which is aligned axially parallel to the input shaft arrangement, i.e., in parallel to and offset from the input shaft arrangement. The first electric machine 60′ is connected to the input element of the dual-clutch assembly 20 via a first machine-coupling gear set 66. This example embodiment as well can contribute to a compact design. Moreover, electric machines can be utilized, which are operated at very high rotational speeds, since, due to the machine-coupling gear set 66, an adaptation to the rotational speed of the internal combustion engine 12 can take place. As a result, the first electric machine 60′ can be designed to be highly compact.

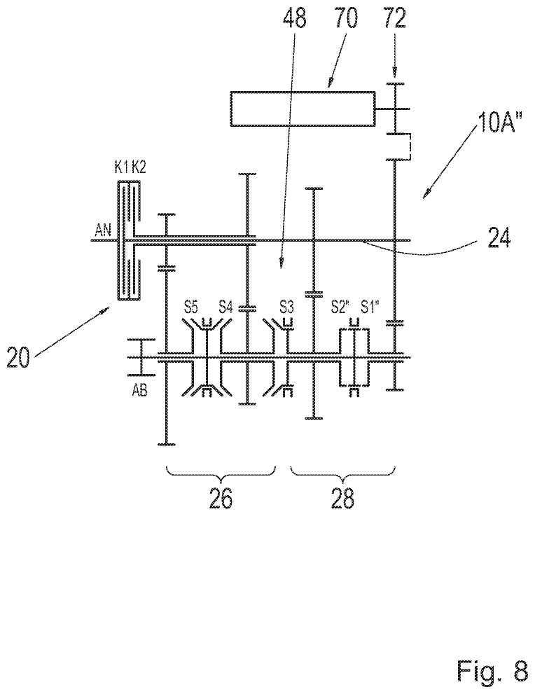

In FIG. 8, 10A″ shows a further example embodiment of a drive train, in which a first electric machine is not provided. A second electric machine 70 is provided, however, which is connected to the second input shaft 24 via a second machine-coupling gear set 72. More precisely, the second electric machine 70 includes a rotor, which is connected to a machine pinion, which is in engagement—directly or via an intermediate gearwheel—with a fixed gear of one of the gear sets for the third or fifth forward gear steps 3 or 5, in the present case with the fixed gear of the gear set for the fifth forward gear step 5.

In the example embodiments from FIGS. 7 and 8, the first electric machine 60′ and the second electric machine 70, respectively, can be designed to be in axial overlap with at least a portion of the transmission arrangement and/or the dual-clutch assembly 20, in order, in this way, to achieve a compact design. The axial extension of the electric machine 60′ and/or of the electric machine 70 is smaller than the axial length of the sub-transmissions 26, 28 and of the dual-clutch assembly 20.

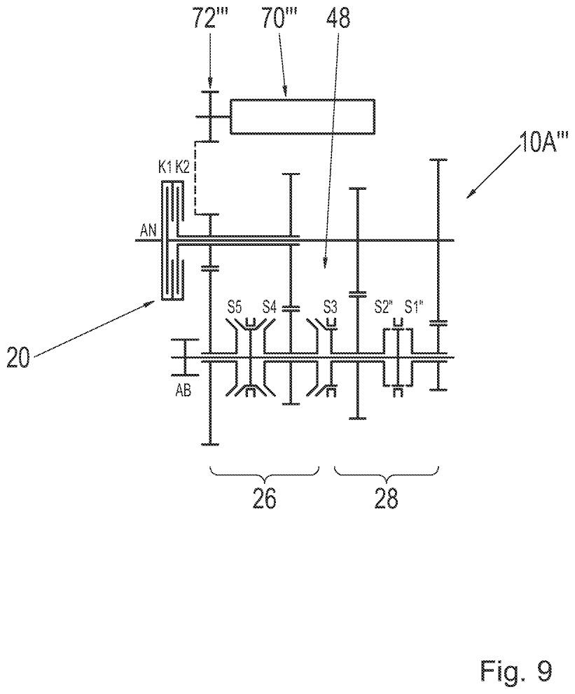

In FIG. 9, a further alternative example embodiment of a drive train 10A′″ is shown, in which a second electric machine 70′″ is connected to the first sub-transmission 26 via a second machine gear set 72′″ and, in fact, to a fixed gear of one of the gear sets of the first sub-transmission 26, in the present case to the fixed gear of the gear set for the regular second forward gear step 2. The connection can take place directly, or, preferably, via an intermediate gearwheel, which is indicated via a dashed line in FIG. 9 (similarly to FIG. 8).

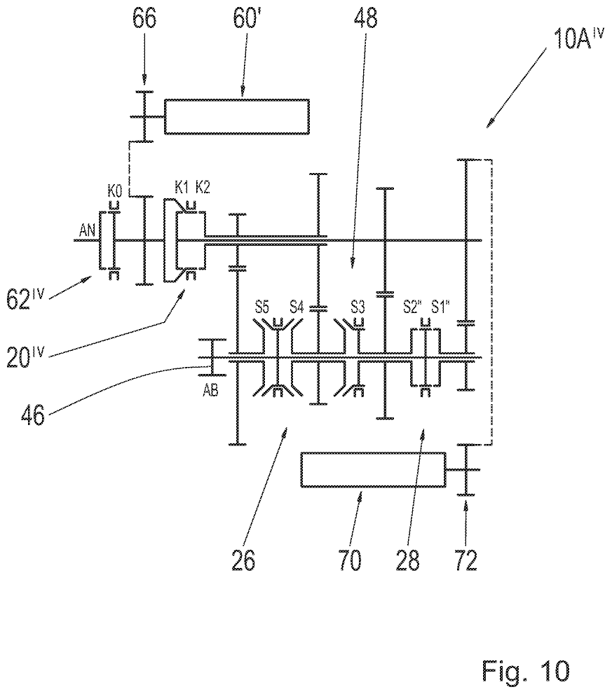

In FIG. 10, a further preferred example embodiment of a drive train 10A^{IV} is shown. In the drive train 10A^{IV}, essentially the drive concepts from FIGS. 8 and 9 are combined with each other. Here, the drive train 10A^{IV} includes a first electric machine 60′, which is connected to an input element of the dual-clutch assembly 10A^{IV} via a first machine gear set 66. Moreover, a second electric machine 70 is connected via a second machine gear set 72 to the second sub-transmission, more precisely, to the fixed gear of the gear set for the fifth regular forward gear step 5.

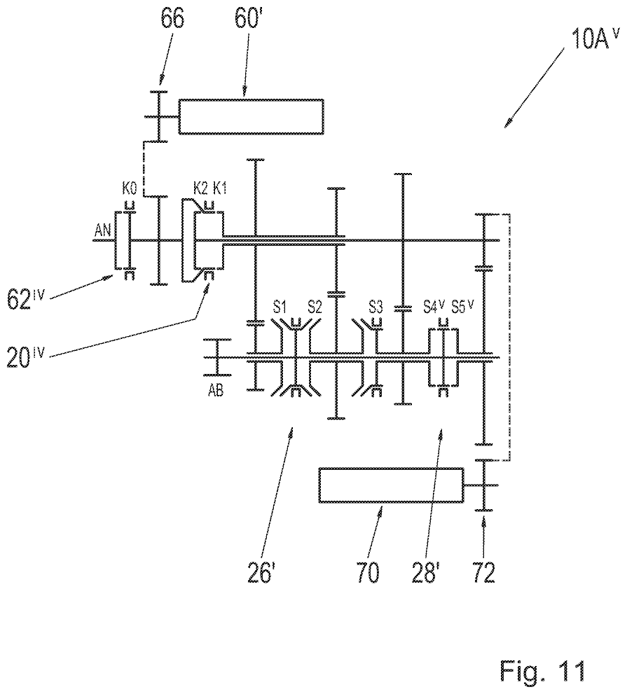

In FIG. 11, a further example embodiment of a drive train 10A^{V} is represented, which generally corresponds to the drive train 10A^{IV} from FIG. 10 with respect to configuration and mode of operation. In the drive train 10A^{V}, however, the axial arrangement of the sub-transmissions 26′, 28′ is interchanged and, in fact, just as in the drive train 10′ from FIG. 2. Here, the first sub-transmission 26′ includes the regular third and fifth forward gear steps 3 and 5, and the second sub-transmission 28′ includes the regular second and fourth forward gear steps 2 and 4, wherein the second machine gear set 72 is connected to a fixed gear of the gear set for the second forward gear step 2.

In the drive trains 10A^{IV} and 10A^{V}, the first electric machine 60′ is preferably axially aligned with the dual-clutch assembly 20^{IV} and the first sub-transmission 26 and 26′, respectively, and extends essentially from the input element of the dual-clutch assembly 20^{IV} up to the bridge clutch arrangement 48.

The second electric machine 70 is arranged in the axial direction between the gear sets of the two sub-transmissions 26, 28 situated farthest apart from each other, i.e., in axial overlap with the transmission arrangement, which is formed from the sub-transmissions 26, 28.

In the example embodiments from FIGS. 1 and 2 and in most of the further example embodiments, the shift elements S1 through S5 are implemented as synchromesh shift elements or shift elements with friction elements, in particular as lock-synchronizer mechanisms.

In the drive train from FIG. 8, the second electric machine 70 is connected to the second sub-transmission 28. It is possible, therefore, to implement the shift elements S1″ and S2″ of the drive train 10A″ as non-synchronized shift elements and/or as dog clutches.

This is represented accordingly in FIG. 9, wherein, here, the second electric machine 70″ is connected to the first sub-transmission 26, and so it is also possible to implement the shift elements S4 and S5 as non-synchronized shift elements and/or dog clutches.

In the example embodiments from FIGS. 10 and 11, the shift elements S2″, S1″ and S4^{V}, S5^{V} of the second sub-transmission 28, 28′, respectively, to which the second electric machine 70 is connected, can be designed as non-synchronized shift elements and/or dog clutches. Moreover, it is possible to implement the dual-clutch assembly 20^{IV} of the drive trains from FIGS. 10 and 11 in the form of essentially non-synchronized shift elements and/or dog clutches, since a synchronization, if necessary, can take place via the first electric machine 60′. For the same reason, the internal combustion engine-decoupling device 62^{IV} in the example embodiments from FIGS. 10 and 11 can also be designed as a non-synchronized shift element and/or dog clutch K0.

In the example embodiments from FIGS. 6 and 7 as well, the internal combustion engine-decoupling device 62 can be designed as a friction-locking or form-locking clutch.

In all example embodiments, it is understood that, instead of a gear set for connecting an electric machine (machine gear sets 66 and 72), chains or belts are also usable in each case, in order to connect the particular electric machine.

In the example embodiments, in which only one electric machine is provided, which is connected to a sub-transmission in each case (FIGS. 8 and 9), a purely electric operation can take place via the gear steps that are associated with the associated sub-transmission. For example, a purely electric operation can take place in the example embodiment from FIG. 8 via the first, third, and fifth forward gear steps 1, 3, and 5. In the example embodiment from FIG. 9, a purely electric operation can take place via the second, fourth, and sixth forward gear steps 2, 4, and 6. Gear changes in the purely electric operation are then possible only with an interruption of tractive force. An internal combustion engine-decoupling device is not necessary, since the electric machine can be decoupled from the internal combustion engine 12 via the associated dual-clutch assembly 20.

In the example embodiments from FIGS. 10 and 11, in which two electric machines are provided, a gear change can also take place, if necessary, in the purely electric operation while maintaining the tractive force (depending on the size ratio of the electric machines with respect to each other).

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 drive train
12 internal combustion engine
14 dual-clutch transmission
16 differential
18 driven wheels
20 dual-clutch assembly
22 first input shaft
24 second input shaft
26 first sub-transmission
28 second sub-transmission
30 gear set for regular forward gear step 2
32 gear set for regular forward gear step 4
34 gear set for regular forward gear step 3
36 gear set for regular forward gear step 5
40 countershaft
42 first gearshift clutch assembly (2/4)
44 second gearshift clutch assembly (3/5)
46 output pinion
48 bridge clutch arrangement (S3)
52 further countershaft
54 first coupling gear set
56 second coupling gear set
60 first electric machine
62 internal combustion engine-decoupling device
66 first machine-coupling gear set
70 second electric machine
72 second machine-coupling gear set
K1 second clutch (20)
K2 first clutch (20)
S1 shift element (5)
S2 shift element (3)
S3 shift element (48)
S4 shift element (4)
S5 shift element (2)

1-15: (canceled)

16. A transmission arrangement for a motor vehicle drive train (10), comprising:
a first input shaft (12);
a second input shaft (24);
a countershaft (40);
a first sub-transmission (26) comprising a first plurality of engageable gear sets (30, 32) for establishing gear steps;
a second sub-transmission (28) comprising a second plurality of engageable gear sets (34, 36) for establishing gear steps; and
a bridge clutch (S3) configured for selectively coupling the first sub-transmission (26) and the second sub-transmission (28) in order to establish at least one winding-path gear step (V1, V6).

17. The transmission arrangement of claim 16, wherein the bridge clutch (S3) is arranged at the countershaft (40).

18. The transmission arrangement of claim 17, wherein the bridge clutch (S3) is arranged axially between the first sub-transmission (26) and the second sub-transmission (28).

19. The transmission arrangement of claim 16, further comprising a further countershaft (52) coupled to the first sub-transmission (26) via a first coupling gear set (54) and to the second sub-transmission (28) via a second coupling gear set (56), the bridge clutch (S3″) arranged at the further countershaft (52).

20. The transmission arrangement of claim 19, wherein the bridge clutch (S3″) is arranged axially outside an axial gap between the first coupling gear set (54) and the second coupling gear set (56).

21. The transmission arrangement of claim 16, wherein one or both of the first sub-transmission (26) and the second sub-transmission (28) has precisely two gear sets associated with regular forward gear steps.

22. The transmission arrangement of claim 16, wherein one or both of:
ratios of one or both of the first plurality of engageable gear sets (30, 32) and the second plurality of engageable gear sets (34, 36) are matched to one another such that a first forward winding-path gear step (V1) has a shorter ratio than all of the first and second pluralities of engageable gear sets (30, 32, 34, 36) associated with regular forward gear steps; and
ratios of one or both of the first plurality of engageable gear sets (30, 32) and the second plurality of engageable gear sets (34, 36) are matched to one another such that a second forward winding-path gear step (V6) has a longer ratio than all of the first and second pluralities of engageable gear sets (30, 32, 34, 36).

23. A drive train (10) for a motor vehicle, comprising:
an internal combustion engine (12);
a dual-clutch assembly (20) comprising an input element connected to the internal combustion engine (12) and two output elements; and
the transmission arrangement of claim 16,
wherein the first input shaft (22) and the second input shaft (24) are each connected to a respective one of the two output elements.

24. A hybrid drive train (10A), comprising:
the transmission arrangement of claim 16;
a dual-clutch assembly (20) comprising two output elements;
a first electric machine (60) connected to an input element of the dual-clutch assembly (20); and
a second electric machine (70) connected to the first input shaft (22) or to the second input shaft (24),
wherein one or both of
the first input shaft (22) and the second input shaft (24) are each connected to a respective one of the two output elements, and
one of the two output elements is connected with the second electric machine (70).

25. The hybrid drive train of claim 24, further comprising an internal combustion engine-decoupling device (62) configured for selectively connecting an internal combustion engine (12) to the input element, the input element of the dual-clutch assembly (20) connected to the internal combustion engine-decoupling device (62).

26. The hybrid drive train of claim 24, wherein one or both of:
the first electric machine (60) is connected to the input element via a first machine-coupling gear set (66); and
the second electric machine (70) is connected to the first input shaft (22) or to the second input shaft (24) via a second machine-coupling gear set (72).

27. The hybrid drive train of claim 24, wherein:
the first electric machine (60) is connected to the input element of the dual-clutch assembly (20);
the second electric machine (70) is connected to the first input shaft (22) or to the second input shaft (24); and
gear sets of the one or the first and second sub-transmissions that is associated with the second electric machine (70) are engageable by unsynchronized gearshift clutches and/or dog clutches (S2″, S1″; S4V, S5V).

28. The hybrid drive train of claim 24, wherein:
the first electric machine (60) is connected to the input element of the dual-clutch assembly (20);
the second electric machine (70) is connected to the first input shaft (22) or to the second input shaft (24); and
the dual-clutch assembly (20IV) includes one or both of a first and a second unsynchronized gearshift clutch or dog clutch.

29. The hybrid drive train of claim 25, wherein the internal combustion engine-decoupling device (62IV) comprises an unsynchronized gearshift clutch or dog clutch.

30. A method for operating the hybrid drive train (10A) of claim 24, comprising synchronizing gear changes of unsynchronized gearshift clutches with one or both of the first electric machine (60) and the second electric machine (70).
